(19) United States
(12) Patent Application Publication
(10) Pub. No.: US 2005/0156032 A1
(43) Pub. Date: Jul. 21, 2005

(54) Aids in the purchase and sale of packaged foods

(76) Inventor: Mitch N. Milstein, Newport Coast, CA (US)

Correspondence Address: Mitch N. Milstein, 12 Sail Vista, Newport Coast, CA, 92657, US

(21) Appl. No.: 11/040,051

(22) Filed: Jan. 20, 2005

Related U.S. Application Data
(60) Provisional application No. 60/537,653, filed on Jan. 20, 2004.

(51) Int. Cl. G06K 15/00

(52) U.S. Cl. 235/383

(57) ABSTRACT

The present invention is directed toward systems and methods that aid a shopper in determining whether to purchase a packaged food product. After scanning the product label, relevant information about the product is displayed for the shopper. Such information includes nutritional information and diet specific information.

This application claims the benefit of U.S. provisional application No. 60/537,653 filed on Jan. 20, 2004 and incorporated herein by reference in its entirety.

### FIELD OF THE INVENTION

The field of the invention is grocery store systems.

### BACKGROUND OF THE INVENTION

Access to useful information is relatively easy to obtain in today's society. For instance, a consumer that is shopping for a musical compact disk can pass the disk under a scanner and hear portions of songs on the disk. The consumer can then make a more informed decision on whether to purchase the disk.

In a grocery store, consumers are forced to read product labels to obtain on-the-spot information about food products. Many times, however, either the information that the consumer wants is not on the label or the information is printed too small for the consumer to read. Sometimes, it is just too much of a burden for a consumer to search out the relevant information he is seeking. In addition, there are many diets that require consumers to examine labels and even make calculations before deciding whether to purchase a food product.

Up to now, this type of readily accessible information has not been accessible for consumers purchasing groceries.

### SUMMARY OF THE INVENTION

The present invention provides methods and devices for aiding a consumer in the purchase of a packaged food product. More specifically, a system for selling a packaged food product includes a scanning mechanism that reads a product label and a display screen that displays nutritional and diet specific information about the packaged food product. In a further aspect, a shopper can select a specific diet and receive information relevant to the specific diet.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

FIG. 1 is a schematic of a system for selling a packaged food product.

FIG. 2 is a display screen for selecting a specific diet.

FIG. 3 is a display screen with diet specific statistics.

FIG. 4 is a schematic of system according to the present invention including a communications link to a remote device.

FIG. 5 is a flow diagram of a method of aiding a consumer in the decision of whether to purchase a food product.

### DETAILED DESCRIPTION

Referring first to FIG. 1, a system 100 for selling a packaged food product 130 generally includes a display screen 110 and a scanning mechanism 120.

Packaged food product 130, in this case, is a 6 oz. can of Pinto Beans with a bar code label 135. It should be understood that a packaged food product refers to a product that people or animals consume by eating. The packaging can include a wrapper, a box, a label printed on the product, a label stuck to the product, a label attached to the product, and so on. The only requirement for a packaged food product is that the product be for consumption by a person or other animal and that the product have a label or otherwise a means of identifying the product.

Display screen 110 preferably has touch screen capability so that a shopper can actuate a selection by touching the screen. In other embodiments, actuation can be accomplished by using a stylus, which may be attached to a cord that connects to the display screen. One of skill in the art will understand that a display screen simply shows information to someone and many types of displays will be appropriate for this use including a CRT type monitor, an LCD, an HDTV and so on. In most cases a color monitor will be used, however, monochrome monitors will also work.

It is preferred that both a display screen and a scanning mechanism be mounted in an aisle of a grocery store. As such, a single device having a display screen and a scanning mechanism can be permanently mounted to a shelf that houses packaged food products. Alternatively, the screen and the scanning mechanism can be separate so long as the scanning mechanism is readily accessible to a shopper.

In a further aspect, the inventive concept can include a speaker and other hardware and software that allow the system to audibly relate nutritional information and diet specific statistics. This may be especially useful for people who are not able to read well for one reason or another.

Scanning mechanism 120 is preferably a bar code scanner but other types of scanners are contemplated. For example, a device that performs an optical character recognition may also be used. Also contemplated are scanning mechanisms that read RF (radio frequency) ID tags. In any case, the scanning mechanism functions to read information on the product label.

It can be observed that nutritional information such as the number of calories, grams of protein, and carbohydrates are displayed on the display screen. It should be understood that the display screen can display many more types of information about the product including source information and transportation information about the food product. Thus, consumers can decide how fresh a product is or whether a product comes from a lot or location that has been associated with e-coli or other dangerous microorganisms. Of course, a display screen can show video information such as infomercials about the products or even advertisements for related and unrelated products.

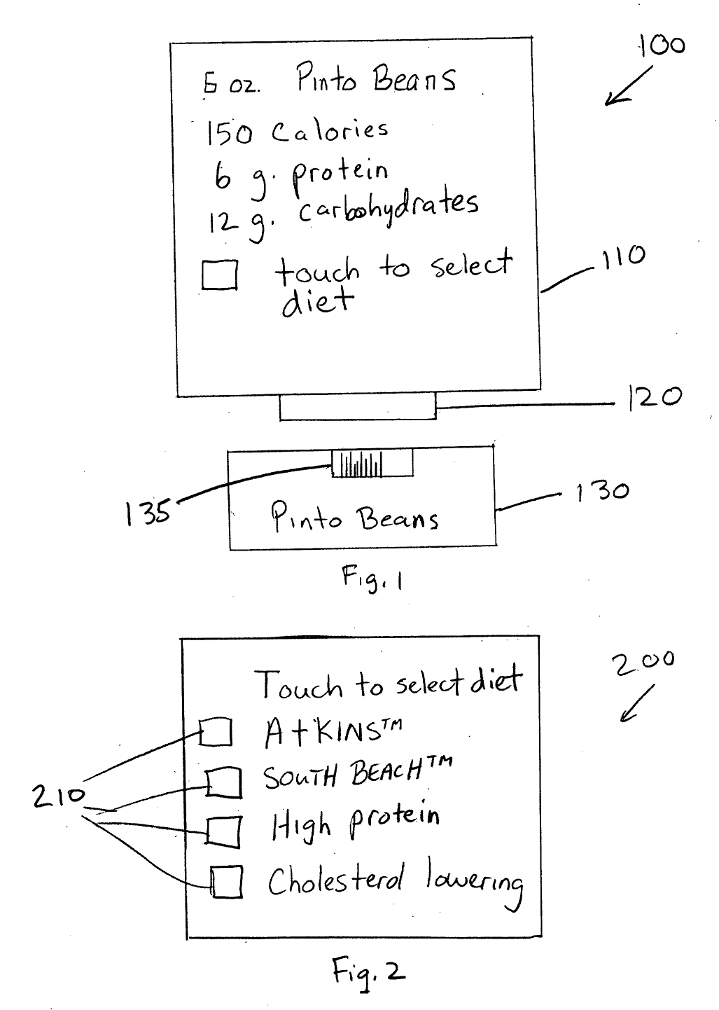

In FIG. 2, a diet specific selection screen 200 displays specific (e.g. Atkins™) and general (e.g. high protein) diets. In addition, boxes 210 allow for selection of the specific diet. Once a user (shopper) selects a specific diet, statistics about the particular food product that was scanned are displayed. FIG. 3 depicts some exemplary diet specific statistics on a display screen 310. The diet specific statistics can be derived from information on the product label or otherwise can be accessed from a local or remote database that stores such information. In some cases, it may be advantageous for diet specific information to be provided by an independent health agency or the company that sponsors the specific diet.

It should be pointed out that diet specific information can include many other types of information than those shown on display screen 310. Diet specific information can be information that is tailored by medical professionals to deal with specific medical problems. For instance, a doctor may determine that foods high in oil or fat will help a person suffering from dry skin. In this case, statistics on oil or fat content may be displayed. In another example, a “hair and nail diet” may be selected, and in this case, diet specific information can include grams of protein and quantity of B vitamins and potassium.

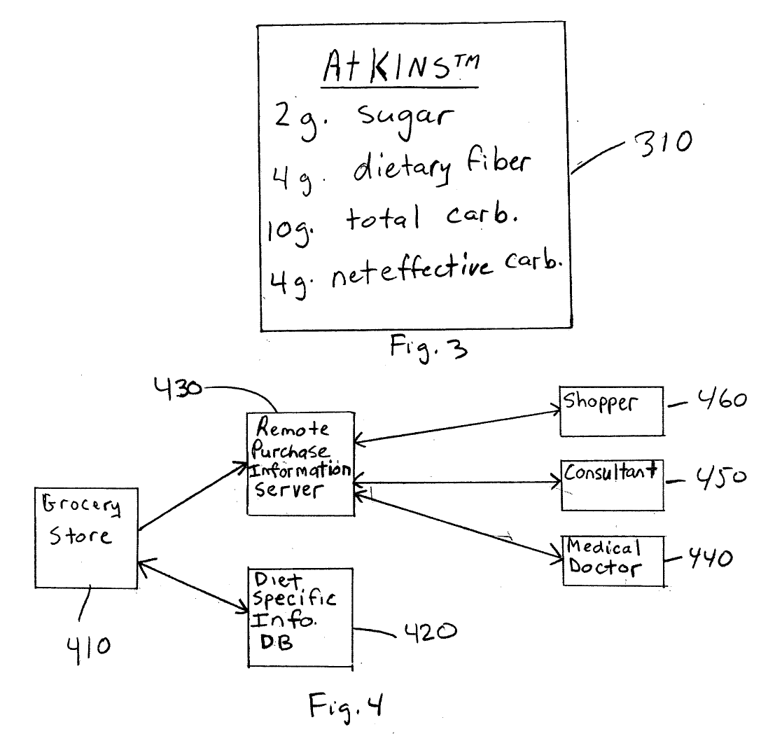

FIG. 4 shows communication paths for a contemplated class of embodiments. As previously indicated, a scanning mechanism and display screen are located in a grocery store 410, for example. The system in the grocery store 410 uses information from the product label to access diet specific information stored on a diet specific information database 420. The diet specific information database may be housed within a grocery store or more preferably housed remotely.

Remote purchase information server 430 is a device that stores and tracks information about the purchases of a particular shopper. Purchase information can include the type of product purchased, the size of the product, and related nutritional information about the product. Thus, a doctor 440, a diet consultant 450, or even the shopper himself 460 can track purchases and determine whether the correct foods and quantities of those foods are being purchased in order to accomplish a diet related goal.

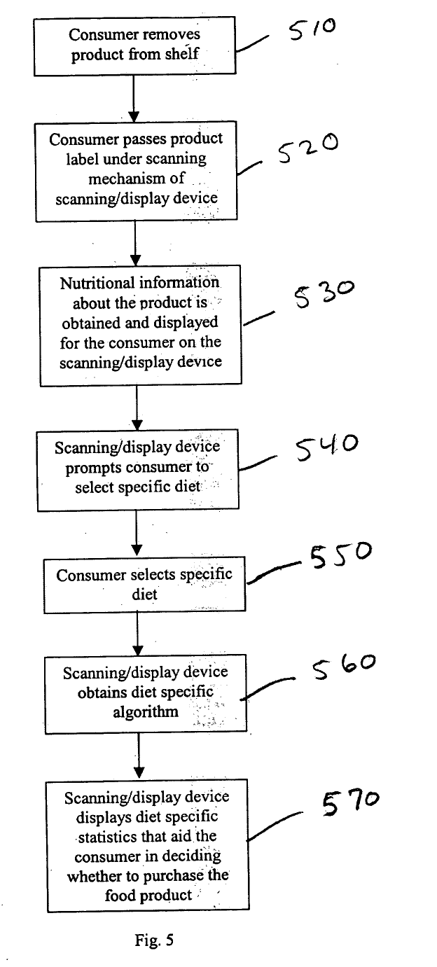

Focusing now on FIG. 5, a method of aiding a consumer in a decision of whether to buy a food product generally includes the steps of: a consumer removing a product from a shelf 510; the consumer passing a product label under a scanning mechanism of the scanning/display device 520; obtaining and displaying nutritional information about the product 530; prompting the consumer for selection of a specific diet 540; the consumer selecting the specific diet 550; obtaining a diet specific algorithm 560; and displaying diet specific statistics that aid the consumer in deciding whether to purchase the food product 570.

It should be understood that nutritional information and diet specific information can come from the label of a product (i.e. the information is printed on the label) or the information can come from a database that stores information about the products. Such a database may be resident in the scanning/display device or may be linked to the scanning/display device over a communication path. For example, upon reading a label, a scanning/display device may perform a search on the database using the product id as a key. Once the product is found, relevant information including diet specific statistics, source data, and other data can be displayed for a consumer.

In addition to receiving nutritional information, it is contemplated that a consumer can receive information regarding the source of a product—that is, the path that a food product travels from its origin to the store. Other product related information that can be displayed for a consumer can include portion related information that will enable a consumer to make an informed decision as to how long a product will last in light of dietary restrictions in size of portions. Additionally, product ingredients can be displayed for a consumer.

Consider the following example. A consumer that is practicing the Atkins™ diet goes to the supermarket to do her grocery shopping. A requirement of the Atkins™ diet is that a food product should have a relatively low number of net effective carbohydrates and a relatively low number of sugars. The consumer spots a soup that she wants to buy. She takes the item from the shelf and places it under a scanning/display device mounted within the isle in the supermarket. The device reads the product label and displays nutritional statistics about the product including the total number of calories, the total number of carbohydrates, dietary fiber, and sugars. Because the consumer is desirous of knowing the quantity of net effective carbohydrates per serving and this information is not currently being displayed, the consumer proceeds to select the Atkins™ diet from a list that is presented to her by the device. Once the Atkins™ diet is selected, the device performs a calculation that subtracts the sugars and the dietary fiber from the total carbohydrates in order to derive the net effective carbohydrates. The net effective carbohydrates are displayed for the consumer and she is able to make an informed decision about whether to purchase the food product.

In another example, a consumer selects a steak and places the label associated with the steak under the device for scanning. Upon scanning, the device displays nutritional information about the steak. The consumer, knowing that salmonella has been found in meat from a certain processing plant, makes a selection that prompts the device to display source information about the food product. Upon review of the source information, the consumer is able to decide whether the meat was processed in the suspect processing plant.

It should be appreciated that while this portion of the specification refers to a scanning/display device, it is not necessary that the scanning and display functions be housed in the same physical device. Thus, there can be more than one device or only one device although the preferred embodiment is a single device. As for the display, a 10″ screen is contemplated although almost any size will suffice. Generally speaking, larger screens are more preferable since one of the reasons that a consumer may be using the device is because she is unable to read the small print on the label.

Thus, specific embodiments and applications of the inventive concept have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A system for selling a packaged food product, comprising:
a scanning mechanism that reads a product label on the packaged food;
and a display screen that displays nutritional information about the product on the display screen.

2. The system of claim 1, wherein the scanning mechanism is mounted in an area accessible to shoppers.

3. The system of claim 1, wherein the nutritional information about the product is accessed using at least a portion of the product label.

4. The system of claim 1, wherein the nutritional information is stored remotely.

5. The system of claim 1, further comprising a diet specific actuator that allows a person to select a specific diet and display diet specific statistics relevant to the specific diet.

6. The system of claim 1, wherein source information about the product is accessed using at least a portion of the product label.

7. The system of claim 1, wherein the scanning mechanism is mounted in a grocery store isle.

8. The system of claim 1, wherein the scanning mechanism reads a bar code on the product label.

9. The system of claim 1, further comprising a communications link to a remote device that stores purchase information for the shopper.

10. The system of claim 9, wherein the remote device is accessible by at least one of a shopper, a diet consultant, and a medical doctor.

11. A method of selling a packaged food product, comprising:
providing a scanning device that is accessible to a shopper such that the shopper can readily scan a label associated with the product and receive nutritional information about the product on a display screen.

12. The method of claim 11, further comprising the steps of:
the shopper actuating a diet specific selection; and
receiving diet specific statistics related to the selected diet.
